(19) United States
(12) Patent Application Publication
(10) Pub. No.: US 2014/0032383 A1
(43) Pub. Date: Jan. 30, 2014

(54) ONLINE REAL-TIME ACCOUNTING

(71) Applicant: Yujie Wang, Beijing (CN)

(72) Inventor: Yujie Wang, Beijing (CN)

(73) Assignee: Hangzhou H3C Technologies Co., Ltd., Zone, Hangzhou, Zhejiang (CN)

(21) Appl. No.: 14/110,921

(22) PCT Filed: Apr. 18, 2012
(86) PCT No.: PCT/CN2012/074246

§ 371 Date: Oct. 9, 2013

(30) Foreign Application Priority Data
Jun. 9, 2011 (CN) 201110153732.0

(51) Int. Cl. G06Q 40/00

(52) U.S. Cl. CPC G06Q 40/00
USPC 705/32

(57) ABSTRACT

A method of real time accounting of an online user, comprising, in response to detecting that an accounting period of an online user has expired, transmitting an instant accounting request packet to a Network Access Server (NAS) with an accounting server, in response to receiving an accounting reset packet from the NAS and with the accounting server, performing an instant settlement for expenses of the user according to online usage information carried in the accounting reset packet, recording a result of the instant settlement in a bill of the accounting period that expired recently, restarting to perform accounting for the user from a next accounting period, and transmitting an accounting response packet to the NAS to cause the NAS to clear online usage information of the user and re-calculate the online usage of the user from the next accounting period.

### BACKGROUND

Remote Authentication Dial In User Service (RADIUS) is a networking protocol that provides centralized Authentication, Authorization, and Accounting (AAA) management for computers to connect and use a network service.

Because of the broad support and the ubiquitous nature of RADIUS, it is often used by ISPs and enterprises to manage access to the Internet or internal networks, wireless networks, and etc.

RADIUS is a client/server protocol that runs in the application layer, using User Data Packet (UDP) as a transport protocol. A Remote Access Server, a Virtual Private Network server, a Network switch with port-based authentication, and a Network Access Server (NAS), are all gateways that control access to the network. These have a RADIUS client component that communicates with a RADIUS server. The RADIUS protocol serves three functions as follows:

1. to authenticate users or devices before granting them access to a network,

2. to authorize those users or devices for certain network services, and

3. to account for usage of those services.

### BRIEF DESCRIPTION OF THE DRAWINGS

FIG. 1 is a diagram showing a structure of an access accounting system according to one example of the present disclosure;

FIG. 2 is a flow chart of an instant settlement method for expenses across accounting periods of online users in an AAA system according to one example of the present disclosure; and

FIG. 3 is a diagram showing a structure of a system according to one example of the present disclosure.

FIG. 4 is a diagram showing a structure of an accounting server according to one example of the present disclosure.

FIG. 5 is a diagram showing a structure of a Network Access Server (NAS) according to one example of the present disclosure.

### DETAILED DESCRIPTION

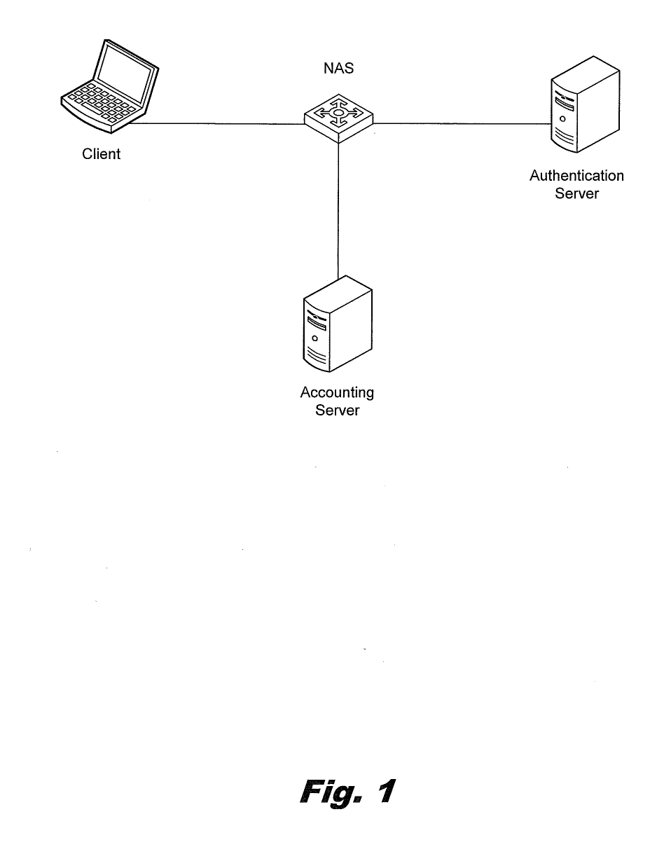

FIG. 1 shows a diagram of the structure of an access accounting system according to one example. In FIG. 1, an NAS is connected respectively with a client, an authentication server, and an accounting server. The NAS bears authentication services between users of the client and the authentication server, records online usage information of the various users, and provides the gathered online usage information for the accounting server.

A RADIUS protocol defines an accounting request packet and an accounting response packet used in an accounting of the users' access to the network. According to various attribute values of the Acct-Status-Type in the accounting request packet, the accounting request packet is divided into three types: an accounting start packet in which the attribute value of Acct-Status-Type is 1, an accounting stop packet in which the attribute value of Acct-Status-Type is 2, and an accounting update packet in which the attribute value of Acct-Status-Type is 3.

In one example, expenses of a user in one online procedure are settled through the accounting start packet and the accounting stop packet provided by the RADIUS protocol. Herein, the so-called “one online procedure” is referred to as a “continuous network service using procedure” which starts from the user's logging on to the network at a certain time and ends at his or her first-time logging off. The specific accounting procedure is as follows:

1. Once the user initiates a log-on request, the NAS sends an authentication request packet to the authentication server and the authentication server feeds back an authentication success packet if identity of the user is correct.

2. After the user has successfully been authenticated, the NAS sends an accounting start packet to the accounting server and the accounting server feeds back an accounting response packet upon receiving the accounting start packet and starts to perform accounting for the user.

3. While the user is online performing various tasks, the NAS may perform a real-time expense settlement for the user through an accounting update packet.

4. After the user logs off, the NAS sends an accounting stop packet to the accounting server, and in response to the accounting stop packet, the accounting server records the settlement result of the expenses generated during the period of time the user was online into a bill representing the user's online usage during the accounting period.

In the above accounting procedure, the accounting server utilizes the accounting start packet and the accounting stop packet to identify a single online procedure of the user. The accounting server also gathers statistics of the user's online usage expenses generated in this online procedure and uses the accounting update packet to implement a real-time calculation of the online user's expenses. However, the expenses of the user generated in this online procedure are settled and recorded in a bill only when the accounting server receives the accounting stop packet or when the time limit for waiting for the accounting update packet expires. Thus, when an online procedure of the user crosses multiple accounting periods, expenses of the whole online procedure will be recorded in the bill of the last accounting period and there will be accounting errors in many circumstances.

In another example, the accounting server: obtains online usage information of an online user upon detecting that an accounting period of the user expires; performs settlement for the expenses of the user across accounting periods instantly according to the obtained online usage information; records the result of the settlement in the bill of the accounting period which expired recently; and, restarts to perform accounting for the user when the user is keeping online. In this example, an instant settlement for the online user's expenses across accounting periods can be realized. As used in the present specification and in the appended claims, online usage may also be referred to as the user's online duration and/or flow consumed by the user.

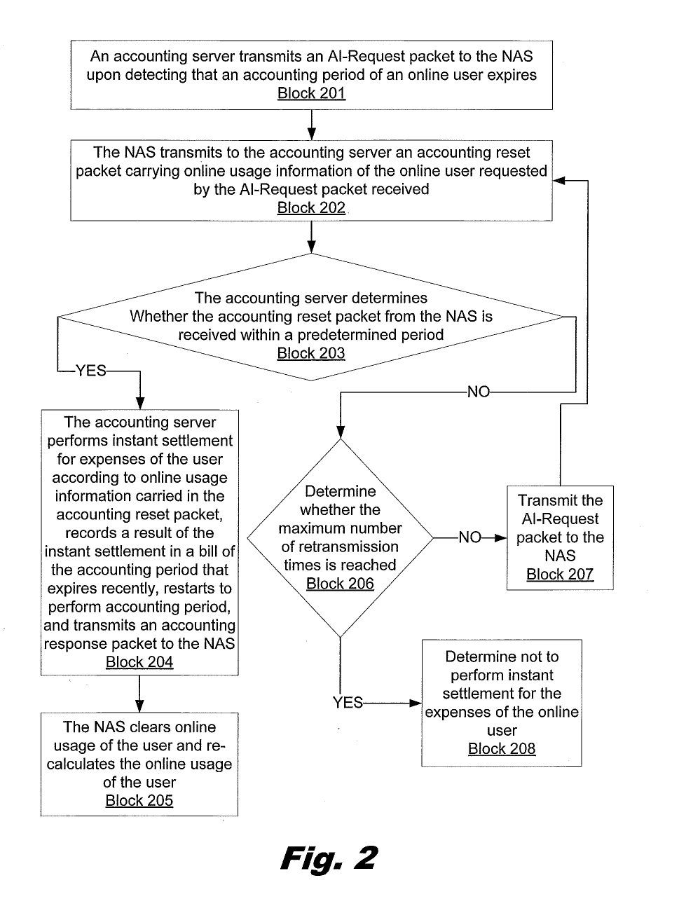

Referring to FIG. 2, a flow chart of an instant settlement method for expenses across accounting periods of online users in an AAA system according to one example of the present disclosure is shown.

Upon detecting that an accounting period of an online user has expired, an accounting server transmits (Block 201) an instant accounting request (IA-Request) packet to an NAS. The IA-Request packet may carry a code field, a session-identification attribute field, an NAS-identification attribute field, and a Service-Type attribute field.

The value of the code field may be predefined as a first code value which may be any code value that has not been used by any other RADIUS packet (e.g., 46).

The session-identification attribute may be used to identify a session of an online user that needs instance settlement for expenses. The session-identification attribute may be a session identifier (Acct-Session-Id) of the online user or any other attribute that may be used to identify the online user's session or a combination of multiple attributes.

The NAS-identification attribute is used to identify the target NAS of the IA-Request packet. The NAS-identification attribute may be any one or any combination of an NAS-IP-address, an NAS-Identifier and an NAS-IPv6-Address.

The value of the Service-Type attribute may be a predefined first attribute value which may be any service-type value that has not been used by any other RADIUS packet (e.g., 15).

After the accounting server detects (Block 201) that an accounting period of the online user expires, the accounting sever, before transmitting the IA-Request packet to the NAS (Block 201), may further: configure the value of the code field in the IA-Request packet as the predefined first code value; configure the value of the session-identification attribute as the session-identification attribute value of the online user (e.g., the identifier of the session the online user currently participates in); configure the value of the Service-Type attribute of the IA-Request packet as the predefined first attribute value; and, configure the value of the NAS-identification attribute of the IA-Request packet as the identification attribute value of the target NAS (e.g., an identifier or an address of the target NAS, or a combination of multiple attributes of the target NAS).

Whether a packet is an IA-Request packet may be determined according to whether the code field of the packet is of the value of the code field in the IA-Request packet. One online user may be uniquely identified according to the value of the session-identification attribute and the value of the NAS-identification attribute in the IA-Request packet.

The accounting server may transmit (Block 201) the IA-Request packet to the NAS to trigger the NAS to perform an instant settlement for the online user's expenses.

The NAS may then transmit (Block 202) an accounting reset packet after receiving (Block 201) the IA-Request packet from the accounting server. The accounting reset packet may carry online usage information of the online user requested by the IA-Request packet.

In one example, the NAS stores each user's session identification attribute upon his logging in. The NAS may further store, in advance, the NAS's own identification attribute and the Service-Type supported by the NAS. When the NAS receives (Block 201) a packet from the accounting server, the packet can be determined as an IA-Request packet if the value of the code field is the predefined first code value. Upon determining the packet is the IA-Request packet, the NAS may identify the online user requested by the IA-Request packet according the session-identification attribute and the NAS-identification attribute carried in the received packet.

In addition, according to tone example, the NAS records various kinds of online usage information of each online user. When the accounting server is to perform expense settlement; the NAS carries one or more kinds of online usage information of a certain online user in an accounting request packet according to practical needs and transmits (Block 202) the accounting request packet to the accounting server. The accounting server may then perform an expense settlement according to the online usage information carried in the accounting request packet. The accounting server may also record related information such as the result of the expense settlement in a bill.

In another example, the NAS carries the online usage information of the online user requested by the IA-Request packet in the accounting reset packet. The NAS then transmits (Block 202) the accounting reset packet to the accounting server in order to realize instant settlement for the expenses of the online user.

The online usage information carried in the accounting reset packet that is used for the instant expenses settlement of the online user may include any one or any combination of the various kinds of online usage information recorded by the NAS. For example, the online usage information carried in the accounting reset packet may include any one or any combination of a session time (Acct-Session-Time), a duration of session delay (Acct-Delay-Time), input bytes (Acct-Input-Octet), output bytes (Acct-Output-Octets), the total number of input packets (Acct-Input-Packets), and the total number of output packets (Acct-Output-Packets). Which kind or kinds of online usage information is to be carried in the accounting reset packet may be determined according to practical needs of accounting. Therefore, upon receiving the accounting reset packet from the NAS, the accounting server may perform instant settlement for online expenses of the online user according to the online usage information carried in the accounting reset packet.

A new accounting request packet which is used in the above example (i.e., the IA-Request packet) may be created by extending the attribute value of an Acct-Status-Type field in the existing accounting request packet and adopting a predefined second attribute value as the attribute value of the Acct-Status-Type field, in which, the predefined second attribute value may be any value that has never been used by any other accounting request packet, e.g., 4. As the new accounting request packet is used, the value of the code field in the accounting reset packet is identical with that in the accounting request packet. In addition, the accounting reset packet transmitted (Block 202) by the NAS may further carry a session-identification attribute field value that is identical with the value associated with the IA-Request packet so as to show that the accounting reset packet is corresponding to the IA-Request packet.

Therefore, before transmitting (Block 202) the accounting reset packet to the accounting server, the NAS may: configure the value of the code field in the accounting reset packet as the value of the code field in the received IA-Request packet; configure the value of the session-identification attribute field in the accounting reset packet as the value of the session-identification attribute field in the IA-Request packet; and, configure the value of the Acct-Session-Type field as the predefined second attribute value.

After the NAS has transmitted (Block 202) the accounting reset packet to the accounting server, the accounting server determines (Block 203) whether an accounting reset packet is received from the NAS within a predetermined period. If it is determined that an accounting reset packet is received from the NAS within the predetermined period (Determination YES, Block 203), the accounting server may perform (Block 204) an instant settlement of expenses of the user. If it is determined that an accounting reset packet is not received from the NAS within the predetermined period (Determination NO, Block 203), the accounting server may determine (Block 206) whether the number of retransmission times for the IA-Request packet reaches a predetermined maximum number of retransmission times. In one example, the predetermined period to receive the accounting reset packet is set according to practical needs.

As mentioned, if it is determined that an accounting reset packet is received from the NAS within the predetermined period (Determination YES, Block 203), the accounting server performs (Block 204) instant settlement for the expenses of the online user according to the online usage information of the online user carried in the accounting reset packet. The accounting server further records (Block 204) the result of the settlement in a bill of the accounting period that recently expired, restarts accounting for the online user from the beginning time of the next accounting period, and transmits an accounting response packet. The NAS may then clear (Block 205) any online usage information of the user and begin to recalculate the online usage of the user.

Upon receiving the accounting reset packet from the NAS within the predetermined period (Determination YES, Block 203), the accounting server performs (Block 204) instant settlement for the user's expenses that the user keeps online and records the result of the expense settlement in the bill of the accounting period that expired recently. This is done so that the expenses of the user will be recalculated from the beginning time of the next accounting period. When a user is online across multiple accounting periods, the online expenses of the user will be recorded in the bills of the respective accounting periods, and consequently the bill of each accounting period can reflect the user's real online usage in each accounting period.

Furthermore, when the result of the expense settlement is recorded (Block 204) in the bill of the accounting period that recently expired, the cause of the user logging-off may also be recorded as an Accounting Online Reset to indicate the expense settlement occurs when the user is online across multiple accounting periods. The accounting is performed again for the online user from the beginning time of the next accounting period by modifying the log-on time of the online user into the beginning time of the next accounting period and clearing the online duration and flow of the online user. After the accounting server restarts performing accounting for the online user from the beginning time of the next accounting period, it may further record in a bill of the next accounting period the settlement result of the expenses from the beginning time of the next accounting period to the log-off time if the user logs off before the next accounting period expires. If the user has not logged off yet at the end of the next accounting period, the instant settlement for the expenses of the user across accounting periods is implemented according to aforementioned method.

Upon accomplishment of the instant settlement for the expenses of the user (Block 204), the accounting server transmits an accounting response packet to the NAS to inform the NAS of the accomplishment of the instant settlement.

The NAS clears (Block 205) the online usage information of the online user upon receiving the accounting response packet from the accounting server to recalculate online usage of the online user.

Additionally, upon receiving the accounting response packet, the NAS may determine that the instant settlement for the expenses of the online user has been accomplished. This may signal to the NAS to begin to gather statistics again for the online user's online usage information from zero.

Therefore, as described above, the instant settlement for the expenses of the user across multiple accounting periods may be finished successfully.

If it is determined that an accounting reset packet is not received from the NAS within the predetermined period (Determination NO, Block 203), the accounting server may then determine (Block 206) whether the number of retransmission times for the IA-Request packet reaches a predetermined maximum number of retransmission times. If it is determined that the number of retransmission times for the IA-Request packet reaches the predetermined maximum number of retransmission times (Determination YES, Block 206)), the accounting server determines not to perform instant settlement for the expenses of the online user. In this example, the accounting server has retransmitted the IA-Request packet a predetermined number of times but has failed to accomplish the expense settlement for the online user. As a result, the accounting server determines not to perform the instant settlement when the maximum number of retransmission times has been reached. The maximum number of retransmission times may be predetermined according practical needs.

If it is determined that the number of retransmission times for the IA-Request packet does not reach the predetermined maximum number of retransmission times (Determination NO, Block 206), the accounting server transmits the IA-Request packet to the NAS and the NAS may then transmit (Block 202) an accounting reset packet. Specifically, if the accounting server has not retransmitted the IA-Request packet for the maximum number of retransmission times (Determination NO, Block 206), the accounting server transmits the IA-Request packet once more to trigger the NAS to perform an instant settlement for the expenses of the online user

Therefore, the instant settlement for expenses of the online user across accounting periods fails if the accounting server determines that the accounting reset packet was not received within a predetermined period and a retransmission of the accounting reset packet was unsuccessful.

In the example of FIG. 2, the accounting server may wait for the accounting reset packet from the NAS after transmitting the IA-Request packet to the NAS, and if the accounting server has not received any accounting reset packet after a predetermined period has expired, it retransmits (Block 207) the IA-Request packet when the maximum number of retransmission times is not reached. However, the accounting server does not retransmit the IA-Request packet if the IA-Request packet is in error, e.g., there is a packet format error, the online user requested by the packet does not exist, or etc. In one example, an instant accounting acknowledgement (IA-ACK) packet and an instant accounting negative acknowledgement (IA-NAK) packet are introduced to reduce unnecessary packet transmission. The IA-ACK packet may be used to notify the accounting server that the IA-Request packet can be processed successfully by the NAS, and the IA-NAK packet may be used to notify the accounting server that the IA-Request packet cannot be processed successfully by the NAS.

As a result after the NAS receives the IA-Request packet from the accounting server (Block 202), the NAS, before transmitting (Block 203) the accounting reset packet to the accounting server, may further determine whether the IA-Request packet can be processed successfully and then transmit an IA-ACK packet to the accounting server if it is determined that the IA-Request packet can processed successfully. Otherwise, the NAS may transmit an IA-NAK packet to the accounting server and, before waiting for the accounting reset packet from the NAS, the accounting server may further wait for receiving the IA-ACK packet or the IA-NAK packet from the NAS. The accounting server may continue to wait to receive the accounting reset packet from the NAS if the accounting server receives is the IA-ACK packet from the NAS. Otherwise if the accounting server receives the IA-NAK packet from the NAS, the accounting server may determine not to perform instant settlement for the expenses of the online user.

Herein, whether the NAS can process the IA-Request packet successfully may be determined according to: the values of the session-identification attribute; the NAS-identification attribute and the Service-Type attribute carried in the IA-Request packet; the session-identification attribute of each online user; the NAS's own identification attribute; and, the service type supported by the NAS itself which are pre-stored in the NAS. The specific determination method may include: searching the session-identification attribute carried in the IA-Request packet in the session-identification attribute of each online user pre-stored in the NAS; determining that the IA-Request packet can be processed successfully if there is a session-identification attribute of an online user identical with the session-identification attribute carried in the IA-Request packet, the NAS-identification attribute carried in the IA-Request packet is identical with the NAS' own identification attribute stored in the NAS, and the Service-Type carried in the IA-Request packet is supported by the NAS; and, otherwise, determining that the IA-Request packet cannot be processed successfully.

If the NAS determines that the IA-Request packet can be processed successfully, the NAS needs to transmit an IA-ACK packet to the accounting server. Herein, the IA-ACK packet at least carries a code field and a session-identification attribute field, in which, the value of the code field is a predefined second code value which may be any code value that has not been used by any other RADIUS packet (e.g., 47), and the session-identification attribute is of a value identical with the value of the session-identification attribute of the IA-Request packet received by the NAS. This may be done so as to show that the IA-ACK packet is in response to the IA-Request packet. Therefore, before transmitting the IA-ACK packet to the accounting server, the NAS may further configure the value of the code field in the IA-ACK packet as the predefined second code value, and configure the value of the session-identification attribute in the IA-ACK packet as that of the IA-Request packet received.

If the NAS determines that the IA-Request packet cannot be processed successfully, the NAS may transmit an IA-NAK packet to the accounting server. In one example, the IA-NAK packet may at least include a code field and a session-identification attribute field, in which, the value of the code field is a predefined third code value which may be any code value that has not been used by any other RADIUS packet (e.g., 48), and the session-identification attribute is of a value identical with the value of the session-identification attribute of the IA-Request packet received by the NAS. This may be done so as to show that the IA-NAK packet is in response to the IA-Request packet. Therefore, before transmitting the IA-NAK packet to the accounting server, the NAS may further configure the value of the code field in the IA-NAK packet as the predefined third code value and configure the value of the session-identification attribute in the IA-NAK packet as that of the IA-Request packet received.

In addition, the IA-ACK packet may further carry an error-cause attribute field. Thus, when the NAS determines that the IA-Request packet cannot be processed successfully, the NAS may further determine an error cause about why the IA-Request packet can not be processed successfully and configure the value of the error-cause attribute field according to the determined error cause. The accounting server, upon receiving the IA-NAK packet from the NAS, may further record the determined error cause in an error log according to the value of the error-cause attribute field in the IA-NAK packet. There may be various error causes about why the IA-Request packet can not be processed successfully. For example, the errors may indicate that there is a packet format error, the online user request does not exist, the NAS-identification attribute carried in the packet does not match the NAS' own identification attribute, etc. In this example, various methods may be used to determine the error cause.

The above description is with regard to the examples of instant settlement for expenses of a single user being online across accounting periods. Additionally, the above examples are also applicable to instant settlement for is expenses of any other user being online across accounting periods and may also be applied to other various scenarios that need instant expense settlement.

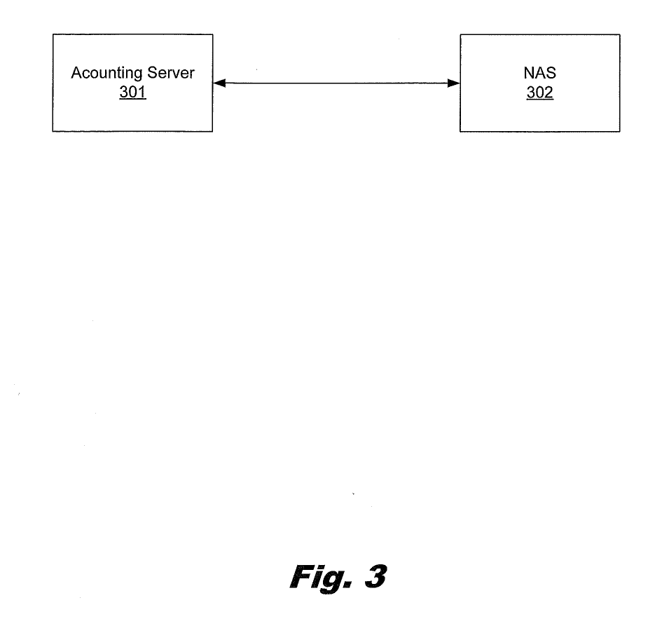

The present disclosure also provides a system which may be applied to instant settlement for expenses of a user being online across accounting periods in an authentication, authorization and accounting (AAA) system. FIG. 3 is a diagram showing the structure of the system according to one example. The system may comprise an accounting server 301 and an NAS 302.

The accounting server 301 transmits an IA-Request packet to the NAS 302 upon detecting that an accounting period of an online user expires. The accounting server 301 also receives from the NAS 302 an accounting reset packet carrying online usage information of the online user requested by the IA-Request packet. Still further, the accounting server 301 performs instant settlement for expenses of the online user according to the online usage information and records the result of the settlement in a bill of the accounting period recently expires. The accounting server 301 may further restart to perform accounting for the online user from the beginning time of the next accounting period and transmits an accounting response packet to the NAS 302.

The NAS 302 transmits to the accounting server 301 the accounting reset packet carrying the online usage information of the online user request by the IA-Request packet upon receiving the IA-Request packet from the accounting server 301. The NAS 302 also clears the online usage information upon receiving the accounting response packet from the accounting server 301 in order to restart to calculate the online usage of the online user from the beginning time of the next accounting period.

The accounting server 301 transmits the IA-Request packet to the NAS 302 again so as to try to request the instant settlement for the expenses of the online user. The accounting server 301 may transmit the IA-Request when the accounting server 301 has not received the accounting reset packet from the NAS 302 within a predetermined period after transmitting the IA-Request packet to the NAS 302 and a predetermined maximum number of retransmission times has not been reached. Otherwise, if the maximum number of retransmission times has been reached, the accounting server 301 determines not to perform instant settlement for the expenses of the online user.

The accounting server 301 may further record the log-off cause of the user as Accounting Online Reset while recording the result of the settlement in a bill of the accounting period that recently expired. The accounting server 301 may further modify the log-on time of the user into the beginning time of the next accounting period and clear the online usage information such as online duration and flow of the user and the like during restarting to perform accounting for the user from the beginning time of the next accounting period. After restarting the performing accounting for the online user from the beginning time of the next accounting period, the accounting server 301 may further record in a bill of the next accounting period the settlement result of the expenses from the beginning time of the next accounting period to the log-off time if the user logs off before the next accounting period expires. If the user has not logged off yet at the end of the next accounting period, the instant settlement for the expenses of the user across accounting periods is implemented according to aforementioned method.

The NAS 302, after receiving the IA-Request packet from the accounting server 301, may further determine whether the IA-Request packet can be processed successfully before transmitting to the accounting server 301 the accounting reset packet. The accounting reset packet may carry the online usage information of the online user requested by the IA-Request packet. The NAS 302 may also transmit an IA-ACK packet to the accounting server 301 if it is determined that the IA-Request packet can be processed successfully. If the IA-Request packet cannot be processed successfully, the NAS 302 may transmit an IA-NAK packet to the accounting server 301.

After transmitting an IA-Request packet to the NAS 302, the accounting server 301 may further: wait to receive the IA-ACK packet or the IA-NAK packet from the NAS 302 before receiving the accounting reset packet from the NAS 302; continue to wait for receiving the accounting reset packet from the NAS 302 if the accounting server 301 receives the IA-ACK packet; or, if the accounting server 301 receives the IA-NAK packet, determine not to perform instant settlement for the expenses of the online user.

The above mentioned IA-Request packet may carry at least a code field, a session-identification attribute field, a Service-Type attribute field, and the NAS-session identification attribute field.

After the accounting server 301 detects that an accounting period of the online user expires, the accounting sever 301, before transmitting the IA-Request packet to the NAS 302, may further: configure the value of the code field in the IA-Request packet as the predefined first code value; configure the value of the session-identification attribute as the session-identification attribute value of the online user; configure the value of the Service-Type attribute of the IA-Request packet as the predefined first attribute value; and, configure the value of the NAS-identification attribute of the IA-Request packet as the identification attribute value of the NAS 302 (i.e., the target NAS).

The NAS 302 may further store each user's session identification attribute, the NAS's 302 own identification attribute, and the Service-Type supported by the NAS 302. Additionally, the NAS 302 may determine whether the received packet is the IA-Request packet. The NAS 302 may accomplish this by determining if the value of the code field in the received packet is the predefined first code value and the value of the Service-Type attribute of the received packet is the first attribute value. Upon determining the received packet is the IA-Request packet, the NAS 302 may determine whether the IA-Request packet can be processed successfully. The NAS 302 may accomplish this by searching the session-identification attribute carried in the IA-Request packet in the session-identification attribute of each online user pre-stored in the NAS 302. The NAS 302 may determine that the IA-Request packet can be processed successfully if: there is a session-identification attribute of an online user identical with the session-identification attribute carried in the IA-Request packet; the is NAS-identification attribute carried in the IA-Request packet is identical with the NAS's 302 own identification attribute stored in the NAS 302; and, at the same time, the Service-Type carried in the IA-Request packet is supported by the NAS 302. Otherwise, the NAS 302 may determine that the IA-Request packet cannot be processed successfully. The IA-ACK packet may at least carry a code field and a session-identification attribute field.

The accounting reset packet above may at least carry a code field, a session-identification attribute field, and an Acct-Session-Type attribute field. Additionally, the IA-NAK packet may at least carry a code field and a session-identification attribute field.

Before transmitting the IA-ACK packet to the accounting server 301, the NAS 302 may further configure the value of the code field in the IA-ACK packet as the predefined second code value, and configure the value of the session-identification attribute in the IA-ACK packet as that of the IA-Request packet received. Before transmitting the accounting reset packet to the accounting server 301, the NAS 302 may further configure the value of the code field in the accounting reset packet as the value of the code field in the received IA-Request packet. Additionally, the NAS 302 may configure the value of the session-identification attribute in the accounting reset packet as that of the IA-Request packet received. Still further, the NAS 302 may configure the value of the Acct-Session-Type attribute in the accounting reset packet as a predefined second attribute value. Before transmitting the IA-NAK packet to the accounting server 301, the NAS 302 may further configure the value of the code field in the IA-NAK packet as the predefined third code value and configure the value of the session-identification attribute in the IA-NAK packet as that of the IA-Request packet received.

In one example, the IA-NAK packet may also carry an error-cause attribute field. Therefore, when the NAS 302 determines that the IA-Request packet cannot be processed successfully, the NAS 302 may further determine an error cause that describes why the IA-Request packet cannot be processed successfully. The NAS 302 may then configure the value of the is error-cause attribute field in the IA-NAK packet according to the determined error cause before transmitting the IA-NAK packet to the accounting server 301.

The accounting server 301, upon receiving the IA-NAK packet from the NAS 302, may further record the determined error cause in an error log according to the value of the error-cause attribute field in the IA-NAK packet.

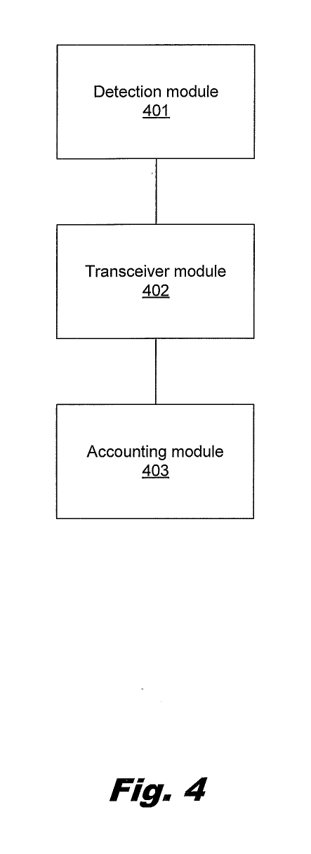

FIG. 4 shows an accounting server that comprises a detection module 401, a transceiver module 402 and an accounting module 403. The detection module 401 is to transmit an instruction to instruct the transceiver module 402 to transmit an instant accounting request packet to a Network Access Server (NAS) (FIG. 3, 302) in response to detecting that an accounting period of a user online has expired.

The transceiver module 402 is to transmit the instant accounting request packet to the NAS (FIG. 3, 302) in response to the instruction from the detection module 401, receive an accounting reset packet carrying online usage information of the user from the NAS (FIG. 3, 302), and transmit an instruction to instruct the accounting module 403 to perform settlement.

The accounting module 403 is to perform instant settlement for expenses of the user according to the online usage information carried in the accounting reset packet received by the transceiver module 402. Additionally, in response to the instruction from the transceiver module 402, the accounting module 403 may record a result of the instant settlement in a bill of the accounting period that expires recently, restart to perform accounting for the user from a next accounting period, and transmit an instruction to instruct the transceiver module 402 to transmit an accounting response packet to the NAS (FIG. 3, 302).

The transceiver module 402 is further to transmit the accounting response packet to the NAS (FIG. 3, 302) in response to the instruction from the accounting module 403 to make the NAS (FIG. 3, 302) clear the online usage of the user and re-calculate the online usage of the user from the next accounting period.

In one example, the transceiver module 402 is further to transmit the instant accounting request packet again to the NAS (FIG. 3, 302). In this example, the transceiver module 403 may transmit the instant accounting request when the transceiver module 402 does not receive the accounting reset packet within a predetermined period after transmitting the instant accounting request packet to the NAS (FIG. 3, 302) and the number of retransmission times of the instant accounting request packet does not reach a predetermined maximum number of retransmission times.

In one example, while recording the result of the instant settlement in the bill of the accounting period that expires recently, the accounting module 403 is further to record a log-off cause of the user as Accounting Online Reset in accounting information corresponding to the accounting period that recently expires. Additionally, during the restarting period where accounting for the user from a next accounting period is performed, the accounting module 403 may record log-on time of the user as beginning time of the next accounting period in accounting information corresponding to the next accounting period. The accounting module 403 may then clear the online usage of the user in the accounting information corresponding to the next accounting period.

In one example, before receiving the accounting reset packet, the transceiver module 402 is further to wait for receiving from the NAS (FIG. 3, 302) an instant accounting acknowledgement (IA-ACK) packet or an instant accounting negative acknowledgement (IA-NAK) packet. The transceiver module 402 may continue to wait for receiving the accounting reset packet when the IA-ACK packet is received. Otherwise, the transceiver module 402 may stop waiting for the accounting reset packet to be received when the IA-NAK packet is received.

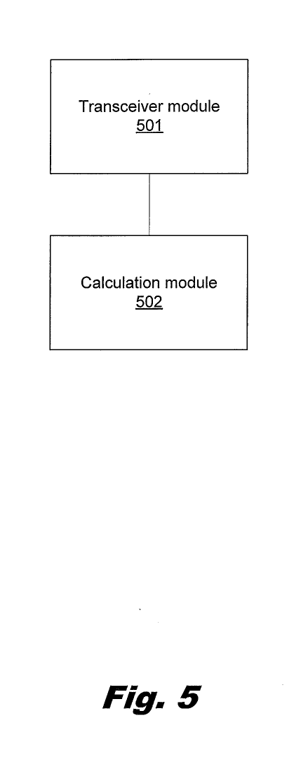

As shown in FIG. 5, the NAS (FIG. 3, 302) may comprise a transceiver module 501 and a calculation module 502. The transceiver module 501, when receiving an instant accounting request packet from an accounting server, may: retrieve online usage information of an accounting period that has expired recently for a user (requested online through the instant accounting request packet); transmit an account reset packet carrying the online usage information in response to receiving the instant accounting request packet; and, transmit an instruction to instruct the calculation module 502 to re-calculate online usage of the user.

The calculation module 502 is to calculate online usage of each user in a network, record online usage information for each user, and clear online usage of the user. The calculation module may further re-calculate the online usage of the user from the next accounting period in response to receiving the instruction from the transceiver module 501.

In one example, the transceiver module 501, before transmitting the accounting reset packet to the accounting server (FIG. 3, 301), is further to determine whether the instant accounting request packet can be processed successfully. The transceiver module 501 may then transmit an instant accounting acknowledgement (IA-ACK) packet to the accounting server (FIG. 3, 301) when it is determined that the instant accounting request packet can be processed successfully. Otherwise, the transceiver module 501 transmits an instant accounting negative acknowledgement (IA-NAK) packet to the accounting server (FIG. 3, 301).

It can be seen from the above examples that the accounting server (FIG. 3, 301) detects the expiring of each accounting period of the online user. Additionally, the accounting server (FIG. 3, 301) transmits an IA-Request packet to the NAS (FIG. 3, 302) each time an accounting period expires. This may be done so as to trigger the NAS (FIG. 3, 302) to initiate an accounting reset request (i.e., the accounting reset packet) for the online user. Consequently, each time the accounting server receives an accounting reset request initiated by the NAS (FIG. 3, 302), it may perform instant settlement for the expenses of the online user, record the settlement result in the bill of the accounting period that recently expired, and restart performing accounting for the user when the user is keeping online. Therefore, when the user stays online across accounting periods, online expenses actually generated in multiple accounting periods can be recorded in the bills of the respective accounting periods, and as a result instant and real-time settlement for the expenses of the user being online across accounting periods can be realized. The above examples can be implemented by hardware, software or firmware or a combination thereof.

For example the various operations, processes and functional modules described herein may be implemented by a processor (the term processor is to be interpreted broadly to include a CPU, processing unit, ASIC, logic unit, or programmable gate array etc.). They may for example be implemented as machine readable instructions stored in a memory and executable by a processor or implemented as hardware logic circuitry of a processor, or a combination thereof. They may be implemented by one processor or split between several processors, therefore reference to a ‘processor’ should be interpreted as meaning ‘a number of processors’, where the ‘number’ may be one or more.

The modules described in the examples above may be provided in a single apparatus or may be distributed between several separate apparatus. Further, the various modules described in the above examples may be integrated into one module or may be further divided into multiple sub-modules.

The methods described above may be presented in a form of machine-readable instructions that are is stored in a non-transitory computer readable storage medium to make a hardware computing device (such as a personal computer, a server, a network device, etc.,) execute the method of the examples.

Examples of possible non-transitory storage media for storing the machine readable instructions include, but are not limited to, a floppy disk, a hard disk, a magnetic disk, compact disk (e.g., CD-ROM, CD-R, CD-RW, DVD-ROM, DVD-RAM, DVD-RW and DVD+RW), a tape, a nonvolatile memory card and ROM. Optionally, it is possible to download the machine readable instructions from a server via a communication network.

In addition, an operating system running on a computer can be enabled to accomplish a part of or all of actual operations described in this disclosure. Moreover, it can be understood that, the machine readable instructions read out by the storage medium can be written into a memory adapted on an extended board inside a computer or be written into a memory adapted in an extended unit connected with a computer. The instructions may then be executed by a processor (e.g. CPU) to implement a part of or all of the methods and operations described in the above examples.

1. A method of real time accounting of an online user, comprising:
in response to detecting that an accounting period of an online user has expired, an accounting server transmitting an instant accounting request packet to a Network Access Server (NAS);
in response to receiving an accounting reset packet from the accounting server:
performing instant settlement for expenses of the user according to online usage information carried in the accounting reset packet,
recording a result of the instant settlement in a bill of the accounting period that expired recently,
restarting to perform accounting for the user from a next accounting period, and
transmitting an accounting response packet to the NAS to cause the NAS to clear online usage information of the user and re-calculate the online usage of the user from the next accounting period.

2. The method of claim 1, further comprising:
recording a log-off cause of the user as an Accounting Online Reset in accounting information corresponding to the accounting period that recently expired while recording the result of the instant settlement in the bill of the accounting period that expired recently;
in which restarting to perform accounting for the user from a next accounting period comprises:
recording, in accounting information corresponding to the next accounting period, a log-on time of the user as a beginning time of the next accounting period, and
clearing the online usage information of the user in the accounting information corresponding to the next accounting period.

3. The method of claim 1, further comprising:
in response to detecting that the user logs off before the current accounting period expired, the accounting server recording in a bill of the current accounting period a result of settlement for expenses of the user from a beginning time of the current accounting period to the log-off time of the user.

4. The method of claim 1, further comprising:
before transmitting the accounting reset packet to the accounting server, with the NAS
determining whether the instant accounting request packet can be processed successfully,
transmitting an instant accounting acknowledgement (IA-ACK) packet to the accounting server when it is determined that the instant accounting request packet can be processed successfully, and
transmitting an instant accounting negative acknowledgement (IA-NAK) packet to the accounting server when it is determined that the instant accounting request packet cannot be processed successfully; and
before receiving the accounting reset packet, the accounting server:
waiting to receive the IA-ACK packet from the NAS,
continuing to wait to receive the accounting reset packet when the IA-ACK packet is received,
stop waiting to receive the accounting reset packet when the IA-ACK packet is not received and
determining not to perform instant settlement for the expenses of the user when an IA-NAK packet is received.

5. The method of claim 4, in which, the instant accounting request packet carries a code, a session-identification attribute, a service-type attribute and an NAS-identification attribute; and the method further comprises:
before transmitting the instant accounting request packet to the NAS with the accounting server:
configuring the value of the code of the instant accounting request packet as a predefined first value code,
configuring the value of the session-identification attribute of the instant accounting request packet as a value of a session-identification attribute of the user,
configuring the value of the service-type attribute of the instant accounting request packet as a predefined attribute value, and
configuring the value of the NAS-identification attribute of the instant accounting request packet as the identification attribute value of the NAS; and
the NAS:
pre-storing the value of the session-identification attribute of each online user, the NAS-identification attribute value of the NAS, and at least one attribute value of at least one service type supported by the NAS, and
determining a packet received is the instant accounting request packet when the value of the code in the received packet is the first code value; and
in which determining whether the instant accounting request packet can be processed successfully comprises:
searching in the pre-stored value of the session-identification attribute of each online user for the value of the session-identification attribute carried in the instant accounting request packet,
determining that the instant accounting request packet can be processed successfully when there is a value of a session-identification attribute of a user identical with the value of the session-identification attribute carried in the instant accounting request packet, the value of the NAS-identification attribute carried in the instant accounting request packet is identical with the NAS-identification attribute value of the NAS (302), and the value of the service-type attribute carried in the instant accounting request packet is one of the at least one attribute value of the at least one service type supported by the NAS, and
otherwise, determining that the instant accounting request packet can not be processed successfully.

6. The method of claim 5, wherein, the IA-ACK packet carries a code and a session-identification attribute, and the accounting reset packet carries a code, a session-identification attribute, and an Acct-Session-Type attribute,
and the IA-NAK packet carries a code and a session-identification attribute;
and wherein the method further comprises:
before transmitting the IA-ACK packet to the accounting server, the NAS:
configuring the value of the code of the IA-ACK packet as a predefined second code value, and configuring the value of the session-identification attribute of the IA-ACK packet with the NAS as the value of the session-identification attribute carried in the received instant accounting request packet; before transmitting the accounting reset packet to the accounting server, the NAS:
configuring the value of the code of the accounting reset packet as the value of the code of the received instant accounting request packet,
configuring the value of the session-identification attribute of the accounting reset packet as the value of the session-identification attribute carried in the received instant accounting request packet, and
configuring the value of the Acct-Session-Type attribute as a predefined second attribute value; and
before transmitting the IA-NAK packet to the accounting server, the NAS:
configuring the value of the code of the IA-NAK packet as a predefined third code value, and
configuring the value of the session-identification attribute of the IA-NAK packet as the value of the session-identification attribute carried in the received instant accounting request packet.

7. A system of online real time accounting, comprising: an accounting server and a Network Access Server (NAS), wherein:
the accounting server is to transmit an instant accounting request packet to the NAS in response to detecting that an accounting period of a online user has expired, to receive an accounting reset packet carrying online usage information of the user from the NAS, to perform instant settlement for expenses of the user according to the online usage information, to record a result of the instant settlement in a bill of the accounting period that expired recently, to restart performing accounting for the user from a next accounting period, and to transmit an accounting response packet to the NAS; and
the NAS is to transmit the account reset packet in response to receiving the instant accounting request packet, and in response to the accounting response packet, to clear online usage information of the user and re-calculate the online usage of the user from the next accounting period.

8. The system of claim 7, in which, while recording the result of the instant settlement in the bill of the accounting period that expired recently, the accounting server is further to record a log-off cause of the user as Accounting Online Reset in accounting information corresponding to the accounting period that recently expired, and during restarting to perform accounting for the user from a next accounting period, to record log-on time of the user as beginning time of the next accounting period in accounting information corresponding to the next accounting period and to clear the online usage information of the user in the accounting information corresponding to the next accounting period.

9. The system of claim 7, wherein, before transmitting the accounting reset packet to the accounting server, the NAS is further to determine whether the instant accounting request packet can be processed successfully, to transmit an instant accounting acknowledgement (IA-ACK) packet to the accounting server when it is determined that the instant accounting request packet can be processed successfully, and otherwise, to transmit an instant accounting negative acknowledgement (IA-NAK) packet to the accounting server; and
before receiving the accounting reset packet, the accounting server is further to wait for receiving the IA-ACK packet from the NAS, to continue to wait for receiving the accounting reset packet when the IA-ACK packet is received, and
otherwise, to stop waiting for receiving the accounting reset packet and determine not to perform instant settlement for the expenses of the user when the IA-NAK packet is received.

10. An accounting server, comprising: a detection module, a transceiver module and an accounting module, wherein:
the detection module is to transmit an instruction to instruct the transceiver module to transmit an instant accounting request packet to a Network Access Server (NAS) in response to detecting that an accounting period of an online user has expired;
the transceiver module is to transmit the instant accounting request packet to the NAS in response to the instruction from the detection module, receive an accounting reset packet carrying online usage information of the user from the NAS, and transmit an instruction to instruct the accounting module to perform settlement;
the accounting module is to perform instant settlement for expenses of the user according to the online usage information carried in the accounting reset packet received by the transceiver module in response to the instruction from the transceiver module, record a result of the instant settlement in a bill of the accounting period that expired recently, and restart to perform accounting for the user from a next accounting period, and transmit an instruction to instruct the transceiver module to transmit an accounting response packet to the NAS; and
the transceiver module is further to transmit the accounting response packet to the NAS in response to the instruction from the accounting module to make the NAS clear online usage information of the user and re-calculate the online usage of the user from the next accounting period.

11. The accounting server according to claim 10, wherein the transceiver module is further to transmit the instant accounting request packet again to the NAS when the transceiver module does not receive the accounting reset packet within a predetermined period after transmitting the instant accounting request packet to the NAS and the number of retransmission times of the instant accounting request packet does not reach a predetermined maximum number of retransmission times.

12. The accounting server according to claim 11, wherein during recording the result of the instant settlement in the bill of the accounting period that expired recently, the accounting module is further to record a log-off cause of the user as Accounting Online Reset in accounting information corresponding to the accounting period that recently expired, and during restarting to perform accounting for the user from a next accounting period, the accounting module is further to record log-on time of the user as beginning time of the next accounting period in accounting information corresponding to the next accounting period and clear the online usage information of the user in the accounting information corresponding to the next accounting period.

13. The accounting server according to claim 10, wherein before receiving the accounting reset packet, the transceiver module is further to wait to receive from the NAS an instant accounting acknowledgement (IA-ACK) packet or an instant accounting negative acknowledgement (IA-NAK) packet,
to continue to wait to receive the accounting reset packet when the IA-ACK packet is received, and
to stop waiting to receive the accounting reset packet when the IA-NAK packet is received when the IA-ACK packet is not received.

14. A Network Access Server (NAS) (302), comprising: a transceiver module (501) and a calculation module (502), in which:
the transceiver module (501), when receiving an instant accounting request packet from an accounting server (301):
retrieves online usage information of an accounting period that expired recently for an online user requested by the instant accounting request packet,
transmits an account reset packet carrying the online usage information in response to receiving the instant accounting request packet, and
transmits an instruction to instruct the calculation module (502) to re-calculate online usage of the user; and
in which the calculation module (502):
calculates online usage of each user in a network,
records online usage information for each user, and
clears online usage information of the user and re-calculate the online usage of the user from the next accounting period in response to receiving the instruction from the transceiver module (501).

15. The NAS (302) according to claim 14, in which the transceiver module (501), before transmitting the accounting reset packet to the accounting server (301), further:
determines whether the instant accounting request packet can be processed successfully,
transmits an instant accounting acknowledgement (IA-ACK) packet to the accounting server (301) when it is determined that the instant accounting request packet can be processed successfully, and
transmits an instant accounting negative acknowledgement (IA-NAK) packet to the accounting server (301) when it is determined that the instant accounting request packet cannot be processed successfully.
